(19) United States
(12) Patent Application Publication
(10) Pub. No.: US 2018/0253813 A1
(43) Pub. Date: Sep. 6, 2018

(54) SYSTEM AND METHOD FOR INCIDENT VALIDATION AND RANKING USING HUMAN AND NON-HUMAN DATA SOURCES

(71) Applicant: International Business Machines Corporation, Armonk, NY (US)

(72) Inventors: DAVID W. KAGUMA, NAIROBI (KE); JIDRAPH NJUGUNA, NAIROBI (KE); TEMITOPE OGUNYOKU, NAIROBI (KE); KOMMINIST WELDEMARIAM, NAIROBI (KE)

(21) Appl. No.: 15/449,161

(22) Filed: Mar. 3, 2017

(51) Int. Cl. G06Q 50/26; G06F 3/0481; G06F 17/27; G10L 15/02

(52) U.S. Cl. CPC G06Q 50/265; G10L 15/02; G06F 17/2785; G06F 3/0481

(57) ABSTRACT

Systems and associated methods are provided that aggregated data from a variety of sources, the data pertaining to an incident. The aggregated data is analyzed and the credibility of the incident report is determined. A response plan is generated and implemented based on the aggregated data and determined credibility of the incident report.

### BACKGROUND

Governments in some countries have not adequately invested on infrastructure that ensures the safety and security of their citizens. High rates of inappropriate or unlawful conduct, rapid urbanization, discovery and processing of natural resources, are some of the main reasons for the growth of insecurity, for example, in cities of some such countries. Cost of insecurity has both local and international downsides, including: drop in tourism, foreign investment, and economic development.

Private Security Companies (PSCs) are growing in result to inadequate public police services. PSCs provide an arrange of services, e.g., Cash & Secure Journey Management, alarm and response, Residential Security and Remote monitoring, but manned guarding is the predominate service. There is a need for integrating technology solutions to increase efficiency in their services and operation and stand out from their competitors.

It is quite common now for security officials or decision makers to have access to various incident data sources, but these sources often require expertise and tedious back-and-forth manual investigation/analysis for incident qualification, characterization, validation, and ranking.

Analytics models do not scale across different data sources, including data outside of reported or observed incidents, e.g., weather, time (hour, day, month, year), demographic, geographic, event, traffic (e.g. road quality). These models are not configured to integrate data in real-time to facilitate intelligent online/offline services (e.g., real-time validation, ranking, risk assessment, and alerting) and decision support system (e.g. resource planning in emergency response, early warning system). They will not, therefore, provide accurate, transparent and traceable insights.

Public safety, incidents extraction, qualification and validation remain an open problem due to the complexity and variability of sources.

The large variability and heterogeneity of the data sources with multiple languages/slang poses great challenges with the collection, aggregation, validation, risk level estimation and overall reactivity to public safety incidents. Inefficient incident reporting and processing, involving several ad-hoc processes to react to an incident, are not desirable. A further challenge is that incident alerts and reports are dense and do not provide relevant information.

Thus, there is a need for developing a novel system and method for distributed validation and ranking of incidents using nontraditional data.

### SUMMARY

In an aspect is a system comprising any combination of the following:

an incident data collection module that aggregates data from various sources. The data contains both structure and unstructured including text components, geospatial components, multimedia components (e.g. pictures, video, speech), etc. both from human and non-human sources;

a text analytics engine that analyzes the text (with multiple languages with possible slang) and identifies types of public safety incident being reported as well as the actors involved;

an image analytics engine that extracts relevant metadata from the pictures submitted as part of the incident report, analyzes the pictures to identify the type of incident by using additional plurality of data sources;

a video analytics engine that analyzes the video content to understand the type and nature of the incident;

a speech analytics engine that analyzes the call-logs, extract relevant metadata and identifies type of incident being reported using the metadata;

an incident qualification engine that analyzes and completes the incident characteristics/attributes (who, what, where, when, why, how etc.);

a validation engine that determines a degree of credibility of an incident with confidence level;

a ranking engine that conducts a risk assessment and computes the impact factors that an incident poses to the public or resources;

an engine that characterize incidents using contextual factors such as tribal and geo-location;

a response planning engine that optimally generates response plans by taking in to consideration available resources, and additional parameters such as power outage sensing, traffic condition sensing, etc.; and

a cognitive advisor module or service.

A system, as above, where incidents are detected and aggregated from non-traditional sources. A system, as above, where incidents are validated and ranked with additional polarity of data sources. A system, as above, where incident is characterized. A system, as above, where the sources providing the intelligence are profiled and characterized. A system, as above, where semantic objects/keywords are associated with the incident. A system, as above, where incidents are time stamped and temporal analysis can be performed. A system, as above, where incidents are geo-tagged and spatial analysis can be performed.

In an aspect is a system comprising an incident data collection module that aggregates data from various sources. In embodiments:

further comprising a text analytics engine that analyzes the text and identifies types of public safety incident being reported as well as the actors involved;

further comprising an image analytics engine that extracts relevant metadata from the pictures submitted as part of the incident report, analyzes the pictures to identify the type of incident by using additional plurality of data sources;

further comprising a video analytics engine that analyzes the video content to understand the type and nature of the incident;

further comprising a speech analytics engine that analyzes the call-logs, extracts relevant metadata and identifies type of incident being reported using the metadata;

further comprising an incident qualification engine that analyzes and completes the incident characteristics/attributes;

further comprising a validation engine that determines a degree of credibility of an incident with confidence level;

further comprising a ranking engine that conducts a risk assessment and computes the impact factors that an incident can pose to the public or resources;

further comprising an engine that characterizes incidents using contextual factors such as tribal and geo-location;

further comprising a response planning engine that optimally generates response plans by taking into consideration available resources, and one or more additional parameters;

further comprising a cognitive advisor services;

where incidents are detected and aggregated from non-traditional sources;

wherein incidents are validated and ranked with additional polarity of data sources;

wherein incidents are characterized;

wherein the sources providing the intelligence are profiled and characterized;

wherein semantic objects/keywords are associated with the incident;

wherein incidents are time stamped and temporal analysis can be performed; and

wherein incidents are geo-tagged and spatial analysis can be performed;

further comprising: a processor; and a memory coupled to the processor, the memory configured to store program instructions executable by the processor.

In an aspect is a method comprising: gathering information pertaining to an incident from at least two sources; reconstructing a detail about the incident based on the gathered information; formulating a response plan based on the gathered information; and communicating the response plan to a recipient. In embodiments:

wherein the at least two sources are selected from social media platforms, a cellular network (e.g. SMS, phone, USSD, etc.), internet, broadcast radio, television, and radio communication systems (e.g. two-way radio or other RF-based systems);

wherein the reconstructed detail is an answer to a question selected from who, what, where, why, how, and when;

wherein the reconstructed detail is information selected from a personal identity, an incident description, an incident time, an incident location, an incident justification or explanation, and an incident modus operandi;

the response plan coordinates a response to the incident;

the response plan coordinates the response to the incidence of police, emergency health providers, and/or other public emergency service providers, and/or private security and/or other private emergency service providers, and/or media reporters;

the communicating of the response plan is via social media platforms, a cellular network (e.g., SMS, phone, USSD, etc.), internet, broadcast radio, television, and radio communication systems (e.g., two-way radio or other RF-based systems);

the recipient is selected from police, emergency health providers, and/or other public emergency service providers, and/or private security and/or other private emergency service providers, and/or media reporters;

a user controls instructions, alerts or actions via a Graphical User Interface (GUI) on a user device, and wherein, using the GUIs, the user can modify, control, interact and configure the processing and parameters of the responses, instructions, alerts, actions, etc.;

further comprising initiating an automated action based on the formulated response plan; and

wherein the automated action is selected from a dispatch of an emergency service provider, a transmission of an alert signal, a change in the alert status of an emergency response system, a phone call to an emergency response team, and the like.

In an aspect is a system comprising: a processor; and a memory coupled to the processor, the memory configured to store program instructions executable by the processor to carry out the methods as above and herein. In embodiments, the system is further comprising a communications module, and one or more I/O devices.

In an aspect is a system for incident characterization and response coordination, the system comprising: an incident data collection module configured to aggregate data from a plurality of sources about an incident; an analytics module selected from a text analytics engine, an image analytics engine, a video analytics engine, and a speech analytics engine, the analytics module configured to analyze aggregated data collected by the incident data collection module and to output an aggregated data analysis; a validation engine configured to determine a degree of credibility of the incident based on the aggregated data analysis; a response planning engine that optimally generates a response plan based on the aggregated data analysis and determined degree of credibility; and a cognitive advisor module configured to implement at least a portion of the response plan. In embodiments:

the cognitive advisor module is connected to a network and is configured to automatically transmit an instruction or alert via the network to a recipient;

the cognitive advisor module is connected to a network via a communications module and is configured to automatically transmit an instruction or alert via the network to a recipient based on the determined degree of credibility of the incident, the instruction or alert being a component of the response plan;

the cognitive advisor module is connected to a network and is configured to automatically transmit an instruction or alert via the network to a recipient, wherein the recipient is selected from a user device, an alarm system, a radio system, a network device, or the like;

the cognitive advisor module is connected to a network and is configured to automatically transmit an instruction or alert via the network to a recipient, wherein the recipient is selected from a user device, an alarm system, a radio system, a network device, or the like, and wherein the instruction or alert is configured to automatically (i.e., without user/human intervention) be implemented by the recipient;

further comprising a ranking engine configured to determine an impact factor that the incident poses to a community based on the aggregated data analysis and determined degree of credibility;

further comprising a contextual characterization module configured to characterize the incident based on contextual factors;

further comprising a contextual characterization module configured to characterize the incident based on contextual factors, and wherein the contextual factors may include, for example, time of day/year, location, weather, political climate, and other news;

the analytics module comprises the text analytics engine, the image analytics engine, the video analytics engine, and the speech analytics engine;

the incident data collection module is configured to aggregate data from sources selected from: a human source; a non-human source; a social media platform; a data network; a radio frequency network; a cellular network; and a traditional media platform;

the response plan coordinates a response to the incident, and comprises at least one instruction for causing an action selected from: an automated action and an action by a recipient;

the response plan coordinates a response to the incident, and comprises at least one instruction for causing an automated action selected from a dispatch of an emergency service provider, a transmission of an alert signal, a change in the alert status of an emergency response system, and a phone call to an emergency response team;

the response plan coordinates a response to the incident, and comprises at least one instruction for causing an action by a recipient, the recipient selected from police, emergency health providers, other public emergency service providers, private security, other private emergency service providers, and media reporters;

the response plan causes the cognitive advisor module to initiate an automatic transmission of a message, or to initiate a change in a user interface;

the response plan causes the cognitive advisor module to initiate an automatic transmission of a message, or to initiate a change in a user device, such as vibrating the user device, generating beep sounds, blinking, triggering changes to user interface;

further comprising a Graphical User Interface (GUI) controlled by a user, the GUI configured to allow the user to control instructions, alerts or actions according to the response plan, and wherein, using the GUI, the user can modify, control, interact and configure processing and parameters of the response, including any instructions, alerts, actions, etc. that form the alert;

further comprising a Graphical User Interface (GUI) controlled by a user, the GUI configured to allow the user to control instructions, alerts or actions according to the response plan;

further comprising an incident qualification engine that analyzes the aggregated data and optional additional data, and assigns additional generic characteristics from a database of similar incidents to the incident; and

the system comprises a processor and a memory coupled to the processor and configured to store machine-readable instructions.

In an aspect is a method for incident characterization and response coordination, the method comprising: receiving, by a system via a network, data about an incident from a plurality of sources and generating aggregated data; generating, via an analytics module, an aggregated data analysis based on the aggregated data; determining a degree of credibility of the incident based on the aggregated data analysis; generating a response plan based on the aggregated data analysis and determined degree of credibility; and implementing at least a portion of the response plan, wherein the implementation comprises at least one of: initiating an automated action and communicating an instruction for an action to a recipient. In embodiments:

the data about the incident comprises text, image, video, or audio data, or a combination thereof;

the data about the incident comprises a combination of at least two of text, image, video, and audio data;

the data about the incident comprises text, image, video, or audio data, or a combination thereof, and wherein the analytics module is selected from a text analytics engine, an image analytics engine, a video analytics engine, and a speech analytics engine, or a combination thereof;

further comprising determining an impact factor that the incident poses to a community based on the aggregated data analysis and determined degree of credibility;

further comprising characterizing the incident based on contextual factors;

the response plan coordinates a response to the incident, and wherein the implementing comprises an automated action selected from a dispatch of an emergency service provider, a transmission of an alert signal, a change in the alert status of an emergency response system, and a phone call to an emergency response team;

the response plan coordinates a response to the incident, and wherein the implementing comprises communicating an instruction to a recipient selected from police, emergency health providers, public emergency service providers, private security, private emergency service providers, and media reporters; and

the response plan coordinates a response to the incident, and wherein the implementing comprises communicating an instruction to a device, the instruction configured to alter a user interface on the device to display a message.

In an aspect is a method comprising: gathering information pertaining to an incident from at least two sources; reconstructing a detail about the incident based on the gathered information; formulating a response plan based on the gathered information; and communicating the response plan to a recipient.

In an aspect is a computer-implemented incident validation and ranking method, the method comprising: determining the degree of incident credibility pertaining to an incident and an impact factor that the incident poses to a community; and generating a response plan based on the determined degree of incident credibility and impact factor.

These and other aspects of the invention will be apparent to one of skill in the art from the description provided herein, including the examples and claims.

### BRIEF DESCRIPTION OF THE DRAWINGS

FIG. 1 provides a schematic for reaching an incident validation value/evaluation according to one embodiment of the invention.

FIG. 2 provides a schematic for obtaining a response plan from a variety of data sources according to one embodiment of the invention.

FIG. 3 provides a schematic for analysing data and producing a response plan according to one embodiment of the invention.

### DETAILED DESCRIPTION

The term “sensor” as used includes binary sensors (i.e., sensing the presence or absence of an event) as well as cameras and other data gathering devices. Further examples include infrared sensors, motion sensors, microphones, and the like.

The process of creating public safety data value streams is very complex and comprehends different phases, including those provided and explained below.

### Data Collection

A first phase is the collection of data. This phase includes collecting as much data pertaining to an incident as possible. In the present invention, incident data may be gathered through informal security networks, from police, media, social media, informal sources, and other open sources. The data may be tagged with metadata including time and geo-location stamps to ensure that related data are grouped appropriately and unrelated data are not included in an analysis. Mostly the data will be in digital format although analog data is not excluded if such is obtained (in which cases the analog data may be converted to digital format for convenience). The data may be in the form of text, image, video, or audio data, or a combination thereof. The data are stored in system memory, either locally or via a distributed (e.g., cloud-type) architecture. In both cases the memory is coupled to (or otherwise accessible by) a processor configured to carry out the steps described herein, such that the processor may access the collected data. Throughout the disclosure, data collected and/or otherwise obtained by the systems herein are referred to as aggregated data where the data are collected from a variety of sources.

Data are collected from a variety of sources, which may include active communication of information from the source to the systems herein, passive gathering of data from the source(s) by the systems herein, or combinations thereof. The incident data may originate from sources selected from: a human source; a non-human source; a social media platform; and a traditional media platform, combinations thereof, or other similar sources. Such sources may include, for example, emergency reports generated by emergency services, reports generated by public or private services (e.g., weather reports, etc.), archived information from databases, sensors such as ground based sensors, airborne sensors, orbiting sensors, and the like. Further examples include client alarms, CCTV video, police reports, news reports, voice calls, and the like.

The systems described herein include an incident data collection module that is configured to collect, retrieve, receive, and/or aggregate the data from the various sources about an incident. The data may be received by any convenient medium, but in embodiments is received via a distributed network. Examples of platforms that can be used to deliver the data include a data network; a radio frequency network; a cellular network (e.g. SMS, phone, USSD, etc.), internet, broadcast radio, television, and radio communication systems (e.g. two-way radio or other RF-based systems). In some cases the medium (i.e., platform used for data transmission) and the source of data are the same or are so linked as to be indistinguishable, and throughout this disclosure they may be used interchangeably where appropriate. The various media mentioned above may furthermore be used by the system to communicate the response plans and instructions derived from response plans as described herein.

The data aggregated is about an incident. Such incident can be any of a variety of incidents, including incidents of unlawful conduct being committed (robberies, beatings, carjacking, etc.), road accidents, fires, natural disasters (tornadoes, earthquakes, etc.), explosions, man-made disasters, transportation accidents (railroad accidents, airline accidents, etc.), accidents (drownings, falls from heights, etc.), building collapses, spills of dangerous or inert substances, natural phenomenon, downed power lines, and the like. Combinations and variations of such incidents may also be the subject of the data. The incident may be one that occurs at a specific incident in time, such as a road accident, or one that occurs over a period of time. In the case of an incident that occurs over a period of time the incident may have concluded or may be on-going during any or all of the data gathering phase.

The methods and systems herein are designed to gather data from a variety of sources, particularly those sources mentioned herein and other sources as appropriate. The data may originate from 2, 3, 4, 5, 6, 7, 8, 9, 10, or more than 10 sources. In the case of social media reports, the data may originate from a large number of sources, such as greater than 10, 50, 100, 200, 500, or 1000 sources.

The incident data collecting module may include or be coupled with an incident aggregation module. The incident aggregation module is configured to aggregate data from a variety of sources where those data apply to (or are likely to apply to) a single incident or related incidents. The incident aggregation module applies hybrid techniques (e.g. based on NLP, image and video matching) to intelligently merge incidents (and the data pertaining thereto) submitted from multiple sources describing similar incident event into a single incident entry. The module takes in input the incident vectors and merges the feature values belonging to the same incident. Different approaches can be applied as will be appreciate in the art. For example, each value in a feature vector is analyzed and compared with a threshold. If the value is above the threshold, then the two incidents are referring to the same incident and are clustered together. While aggregating, the module creates interlinks between the sources and associated information, and keeps up-to-date the CDE.

As described herein, metadata may be attached to data and may be used by the system to determine the relevancy of data to a reported incident. For example, the metadata may include a time stamp or may include geo-tags that allow spatial and temporal analyses for further characterizing the data.

Additional sources of data where relevant and appropriate, may be used (in addition to those mentioned) at the discretion of the operator or others involved in implementation of the system. Examples include data from utility providers (power, water, etc., such as power outage data or the like), traffic sensors, and others.

Although data collection is referred to herein as a “first phase” of the process, this is not necessarily meant to imply that data collection is always/solely conducted first in the processes. For example, data collection may be carried out continuously throughout the processes, even after other phases have begun or finished. Furthermore, throughout this specification, it may be said that the system collects data and “generates” aggregated data—this is meant to describe the process of grouping individual data from a plurality of individual sources.

### Data Analysis

Another phase of the processes herein is data analysis, including data interpretation. This phase involves evaluation of the aggregated data for a variety of purposes, including interpretation, characterization, and grouping of the data. Evaluation may be automatic or may be a manual process, or a combination thereof.

In embodiments, data analysis is carried out by an analytics module in the systems described herein. The analytics module may be configured to analyze aggregated data collected by the incident data collection module and to output an aggregated data analysis. The analytics module may, for example, comprise one or more of the following: a text analytics engine, an image analytics engine, a video analytics engine, and a speech analytics engine. The analytics module may comprise any 2, 3, or all 4 of these engines. The text analytics engine analyzes text data and, for example, identifies types of public safety incident being reported as well as the actors involved. The image analytics engine analyzes image data and, for example, extracts relevant metadata from the pictures submitted as part of the incident report, and may further analyze the pictures to identify the type of incident including by using additional one or more data sources. The video analytics engine analyzes video content to understand the type and nature of the incident and, for example, extract contextual or other information from the data. The speech analytics engine analyzes speech such as call logs, and, for example, extracts relevant information and metadata and identifies type of incident being reported using the information or metadata.

Analysis of the data may further comprise characterizing the incident to which the data applies based on the data and optionally other sources. For example, an incident can be characterized as man-made or natural based on the data received and also based on other data (e.g., weather reports, historical data pertaining to similar sets of circumstances, etc.). Contextual factors such as location may be used in a variety of ways, including determining whether an area is rural or urban, prone to natural disasters, and the like. Characterization of an incident provides a generic type that applies to the incident, and may be used to help with preparation of a response (described herein). As part of the characterization of an incident, a separate incident qualification engine may be present in certain embodiments, wherein such engine uses a variety of contextual data to provide standard/generic attributes about an incident type. Furthermore, the incident may be characterized by associating it with certain semantic objects and/or keywords, again with the goal of improving the response plan for an incident.

Characterization of the incident can, for example, be carried out by a contextual characterization module configured to characterize the incident based on received or determined contextual factors. Contextual factors may include, for example, time of day/year, location, weather, political climate, and other news.

In embodiments, an incident qualification engine may be present that analyzes the aggregated data and optional additional data, and assigns additional generic characteristics to the incident. Generic characteristics may be useful in generating a response plan, particularly where the data for an incident is sparse. For example, generic characteristics can be applied based on historical observations about similar incidents. Thus a further aspect of data analysis may involve reconstructing one or more details about an incident based, for example, on the gathered/aggregated data.

In embodiments, data analysis is carried out by a cognitive data engine (CDE) that does the above analyses and other analyses as appropriate. The CDE may further perform more than a mere analysis, and may be involved in aggregating data based on the analysis of other data. For example, certain data may be determined to be relevant to an incident only after some analysis has been carried out on other data. Thus, in embodiments, the CDE analyzes and aggregates data from a variety of sources human and non-human data sources related to one or more incidents.

In embodiments, the sources providing data are profiled and characterized by the systems and methods provided herein. Such profiling and characterizing may be used, for example, to assist in validating the incident as described herein.

In embodiments, characterization of the data further comprises reconstruction of a detail about the incident based on the aggregated/gathered data. The reconstructed detail may, for example, be an answer to a question selected from who, what, where, why, how, and when as applied to the incident. Alternatively, or in addition, the reconstructed detail may be information selected from a personal identity, an incident description, an incident time, an incident location, an incident justification or explanation, and an incident modus operandi. In embodiments the reconstructed detail may be supplied based on historical data pertaining to similar incidents, or based on other information obtained or supplied.

### Validation and Ranking

Another phase of the processes herein is the verification (also referred to herein as validation) of an incident. This phase has the goal of determining the authenticity of an incident for which data has been collected. Such validation may be carried out using automated processes or manual informal process, for example processes that attempt to establish corroborating sources. In embodiments, a validation engine is used and is configured to determine a degree of credibility of the incident based on the aggregated data analysis. The determined degree of credibility can be provided with a confidence level. Verification can involve, for example, determining the reliability of the various sources of the data aggregated for an incident, and weighting the data according to the various reliability indices. In embodiments the methods involve determining a degree of credibility of the incident based on the aggregated data analysis.

In embodiments, an incident validation engine is used to estimate the probability that an incident is valid with a confidence score (also referred to herein as a degree of incident credibility), and initiates the risk assessment process when the probability crosses a threshold. A confidence score is computed using various components: source ranking, collaborative score, score generated on the basis of the scene analysis, score generated based on similar patterns using past valid incidents, etc. The risk assessment process may, for example, compare the incident with known prior incidents and determine a risk score or other assessment of the risk. The risk assessment may be conducted to assess a variety of types of—e.g., risk of injury to bystanders or people involved in the incident, risk of damage to property, risk of escalation of the incident, and the like. The outcome of the risk assessment may be a risk assessment score (also referred to herein as an impact factor) and/or an instruction (e.g., computer readable or formatted for instructing a human).

A further phase or, alternative, a part of the validation phase, may involve ranking an incident. For example, an incident can be ranked via a ranking engine, wherein the ranking characterizes the risk assessment and furthermore the impact factors that an incident can pose to a community. In embodiments the ranking engine is configured to determine an impact factor that the incident poses to a community based on the aggregated data analysis and determined degree of credibility. Examples of a community to which a risk factor may apply include the general public, a subset of the general public, or resources such as infrastructure and property. In embodiments, a learning agent uses the CDE to validate, assess and assign risk levels to incidents.

The validation and ranking process as described herein may, in embodiments, depend on the semantic information extracted from both multimedia (e.g. images, video, and audio) data and the text data. Such data may be compared in order to aggregate those incidents belonging to the same type while, optionally, using other contextual factors to refine the analysis.

In embodiments, an incident risk assessor module is used and determines the potential risk that the incident would cause (e.g. impact to human and property) using incident coverage, population density in the vicinity of the incident, and other factors as appropriate. The assessor engine starts from the ranked feature value to iteratively assess and decide the risk level. In embodiments, incidents are ranked with additional polarity of data sources

### Response Plan

A further phase of the processes herein is generation of a response plan. The response plan is based on the aggregated data about an incident, and may further be based on other information including data from other sources, contextual data, historical data, and the like as appropriate. User input (i.e., operator input or the like) may also be used in generating a response plan.

A response plan generator module (also referred to herein as a response plan engine) is a decision support system containing a number of algorithms to generate resource plans using the incident characteristic, static and dynamic contextual factors (e.g., traffic, road surface, weather conditions, power outage prediction, etc.), etc., as such information/factors is/are appropriate and available.

In embodiments, a response planning engine optimally generates a response plan based on the aggregated data analysis and determined degree of credibility as determined.

In embodiments, the response plan generator may be coupled to a cognitive incident response advisor that generates resource and response plans, in real-time, for security companies and the public among other potential entities.

In embodiments, the response plan coordinates a response to the incident. In embodiments, the response plan comprises: at least one instruction for causing an action selected from an automated action and an action by a recipient; at least one instruction for causing an automated action selected from a dispatch of an emergency service provider, a transmission of an alert signal, a change in the alert status of an emergency response system, and a phone call to an emergency response team; and/or at least one instruction for causing an action by a recipient, the recipient selected from police, emergency health providers, other public emergency service providers, private security, other private emergency service providers, and media reporters.

In embodiments, the response plan causes the cognitive advisor module to initiate an automatic transmission of a message, or to initiate a change in a user interface.

In embodiments, the response plan may be prepared by taking into consideration available resources, and one or more additional parameters.

In embodiments, the response plan coordinates the response to the incidence of police, emergency health providers, and/or other public emergency service providers, and/or private security and/or other private emergency service providers, and/or media reporters.

In embodiments, the response plan may be presented to an expert for further review and decision making. This provides the CDE with learning outcomes to train on to refine future response plans.

### Dissemination and Implementation

A further phase of the processes herein is dissemination and implementation—i.e., communication of the response plan and optionally additional aspects of the incident, and implementation of the response plan by appropriate entities. In embodiments, dissemination and implementation involves communicating the response plan to a recipient or a plurality of recipients.

As mentioned, dissemination of the response plan (including specific instructions that are part thereof) can be through any of the channels of communication that are described herein, particularly those that are used to receive data from a plurality of sources.

Implementing the response plan or at least a portion of the response plan can involve, for example, initiating an automated action (e.g., an alarm, a response from an emergency service, remotely activating a security feature such as locking of a lock, etc.) and communicating an instruction for an action to a recipient. Recipients can be emergency service providers, relatives of individuals involved in the incident, news reporters, and the like.

Dissemination and implementation may further comprise sending out a message (e.g., by the system via a distributed network) that is intended for receipt by a user device (e.g., a mobile device, a dedicated device, a laptop, a personal computer, etc.), and is configured to cause a change in the user device. The change could be modification of a user interface such as a graphical user interface (GUI), such as displaying on the GUI an alert, instructions, or other information for the user. The change could be to initiate a sensor to begin recording data (e.g., a video camera on a mobile phone or on a law enforcement officer body camera), or to transmit data that was previously recorded. The change could be an audible or visual output such as initiation of an alarm or flashing light (e.g., as deterrents). Other changes are possible and each user device may receive an individually determined instruction/message. The message may be sent to a single user device or to a plurality of user devices as appropriate.

In embodiments, implementing the response plan comprises an automated action selected from a dispatch of an emergency service provider, a transmission of an alert signal, a change in the alert status of an emergency response system, and a phone call to an emergency response team. In embodiments, implementing the response plan comprises communicating an instruction to a recipient selected from police, emergency health providers, public emergency service providers, private security, private emergency service providers, and media reporters. In embodiments, implementing the response plan comprises communicating an instruction to a device, the instruction configured to alter a user interface on the device to display a message.

In embodiments, the systems herein comprise a cognitive advisor module configured to implement at least a portion of the response plan.

In embodiments, implementation of the response plan involves notifying a recipient with instructions or information from the response plan, wherein the recipient is selected from police, emergency health providers, and/or other public emergency service providers, and/or private security and/or other private emergency service providers, and/or media reporters.

Implementing the response plan may comprise initiating an automated action based on the formulated response plan. The automated action may be selected from a dispatch of an emergency service provider, a transmission of an alert signal, a change in the alert status of an emergency response system, a phone call to an emergency response team, and the like.

In embodiments, reports are sent out en masse from historical information. Such reports help recipients of the information understand, for example, the context of the response plan.

Herein, then, there is provided a method and system for understanding and reasoning on scenes composed of complex structured and unstructured data about public safety incidents generated from both human and non-human sources.

The following paragraphs describe an exemplary method of the invention but are provided merely for further describing the invention and are not meant to be limiting.

Incident attributes are extracted from sources that include text, image, video, and audio. The system accepts inputs from one or more devices and/or applications, detects an incident and extracts its features (e.g., answering the questions WHAT, WHERE, WHEN, WHO, HOW, and WHY).

In embodiments, for the given incident under analysis, the goal is to generate a vector {FV} of N features F with an associated value S for the T techniques:

{{[F_{1,1},S_{1,1}], . . . ,[F_{N,1},S_{N,1}]}, . . . ,{[F_{1,T},S_{1,T}], . . . ,[T_{N,T},S_{N,T}]}}

Regarding incident attribute extraction from text, apply NLP algorithms (e.g. Alchemy API taxonomy classifier, Text relations) to determine the WHAT feature from the description of the incident. Build ontology of cities and roads (and landmarks) and use Named Entity extraction tools (such as Alchemy) to determine the WHERE attribute of an incident. A combination of Annotated Query Language (AQL), Named Time Entities, and Text Relations techniques is used to determine the WHEN attribute, by detecting timestamp information from the text description. The WHO is extracted using the nouns detected in the descriptions and parsing them through Named Person Entity extraction techniques such as Alchemy. The HOW is extracted by using a dictionary of commonly used tools in commission of incidents of unlawful conduct using Concept Expansion technique. Use AQL to extract the WHY attribute from the incident description, e.g. by mining patterns of words within the description of the incident like “the reason for the arrest”, “the demonstrators were”, etc.

Regarding incident attribute extraction from an image, extract metadata from the image to determine features of the incident. Use Image analytics and segmentation techniques to further determine entities embedded in the image (e.g., persons, objects) and other metadata. Cognitive algorithms can be used to conduct scene analysis to effectively characterize the nature of the incidents, and derive valuable insights for later operations.

Regarding incident attribute extraction from audio/video (AV) data, the audio and video may be treated separately or together. For any audio input (e.g. phone calls), the system can use automatic transcription techniques and then apply similar methods as of the text input to determine the features of the incident. Extend existing speech/audio recognition techniques/models to handle localization, by building vocabulary/ontology to capture various slang/accents common in the target location. Apply instrumentation and deep learning on the audio input to further understand affect or cognitive states of the source, e.g. the source could be in panic mode due to the nature of the incident. This information can, for example, be used by the validation engine. For the video input, the system can use video analytics techniques to extract values for relevant features and generate other metadata information, or use sophisticated methods to understand the nature of the scene from the video.

Regarding the features, the system may apply advanced learning techniques to qualify the value of each feature based on the values generated by respective algorithms and aggregate in to one value. For each detected incident, the system intelligently summarizes the values into single value. In embodiments it is assumed that the reported incident contains text description and multimedia (image, audio, and video) information from one source. Each of the analytics technique has extracted part or all of the values for the corresponding features. The system can further utilize context information while aggregating and summarizing value(s), which can further use text, image, audio or video analytics as needed.

For each feature, the system applies a feature scoring module to assign a score based on the completeness of the {FV} vector and additional context information. The system may further decide on a set of features needed for the validation process. For example, <WHAT, WHERE, WHEN> are more important than others; the <WHAT> feature can present a high-risk level in the context of human-perpetrated violent attacks designed to coerce for political purposes or the like.

In embodiments, a corroborative score is based on human network and social media. For human networks, a corroboration score is generated when the system identifies reputable human sources in the network that are geographically close to the location and tasks them with corroborating the incident. With social media data, the system generates a set of keywords from the incident description (and their synonyms) and mines for matching reports on various social media platforms.

In embodiments, scene analysis is conducted for incidents that have multimedia present using advanced algorithms to explore the scene of the incident based on the values of the features and associated contextual information (e.g. demographics, geographic, etc.). The extracted affective or cognitive behaviors from the multimedia information can be used to complement such scene analysis.

In embodiments, the invention described herein is focusing on the aggregation, verification, risk analysis of public safety incidents from various complex data sources. The systems and methods have the ability to learn and reason from data collected. The system enables an operator to make quick and informed decisions, thereby increasing her efficiency in providing emergency response teams and clients with real-time credible and relevant information.

The credibility of the source(s) is(are) critical in the reporting of public safety incidents. In embodiments, the systems herein track each of the human sources and runs analytics on their reporting history. A credibility score is assigned to each source. For example, data from a source, where the source is human and was not present at the incident, results in a credibility score below average. The operator can decide she needs to corroborate the incident before she shares the information with her clients and notifies a first responder team to deploy resources.

Human sources of data can furthermore stream and filter keywords from a social media platform such as TWITTER®. To determine whether such information is true, the system can automatically assign a level of credibility. For example, credibility of a social media post is based on the user's profile of the person who created the post, ultimate source of information the person is posting about, and other content of the post. Social media posts with a certain level of credibility are used to extract critical incident parameter data for corroboration (i.e. WHO, WHAT, WHERE, etc.).

Systems are described herein that include a processor and a memory. It shall be appreciated that additional components of the systems may also be present, even where not described herein. Examples include appropriate I/O devices, power sources, and the like. Such components are not described in detail herein but are well known in the art and are readily employed by one of ordinary skill.

Unlike the disclosed systems/methods, known analytic models do not, for example, scale across different data sources, including contextual data outside of reported/observed incidents, e.g., weather, time (hour, day, month, year), demographic, geographic, social events, traffic (e.g. road quality), These models are not able to be configured to integrate data in real-time to facilitate intelligent online/offline services (e.g., real-time validation, ranking, risk assessment, and alerting) and decision support system (e.g. emergency response, early warning system) using frugal technologies especially in areas with resource constrained environs. Thus, the disclosed systems/methods in embodiments satisfy the need for developing a novel system for distributed validation and ranking of incidents based on human and non-human continuous data sources across various domains in the local context.

Various embodiments of the invention are described more fully hereinafter with reference to the accompanying drawings. The invention herein may be embodied in many different forms and should not be construed as limited to the embodiments set forth in the drawings; rather, these embodiments are provided to provide further illustrative non-limiting examples. Arrowheads in the figures are provided merely as examples of directions for the flow of data but are not exhaustive and are not meant to be limiting—i.e., data may flow (where appropriate) in directions that are not shown by arrowheads in the figures. Similar numbers in different figures are meant to refer to similar components.

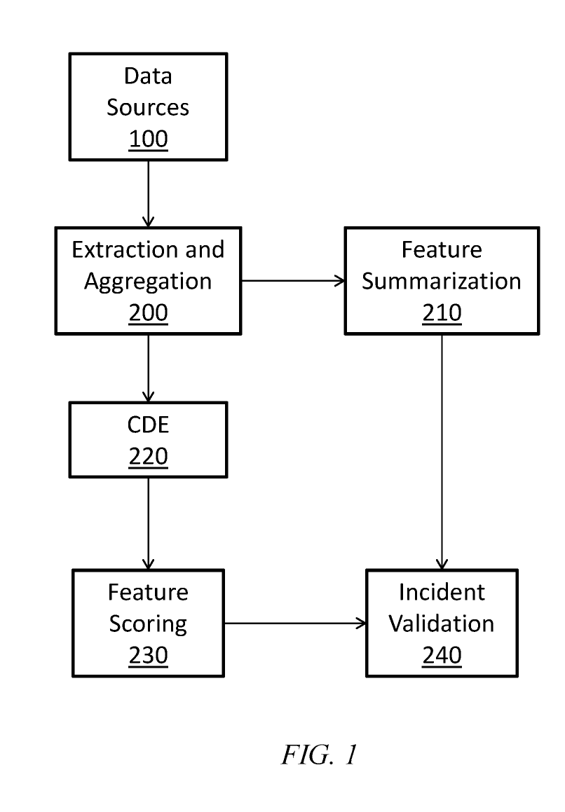

With reference to FIG. 1, there is shown a schematic for reaching an incident validation value/evaluation according to one embodiment of the invention. Data sources 100 may include a variety of sources such as social media, SMS, voice, and the like as described herein. The system receives such data and extracts and aggregates 200 useful data (e.g., text, images, videos, audio, etc.). That data is sent to feature summarization module 210 and also to cognitive data engine (CDE) 220. Furthermore, CDE 220 may act as an incident store and repository for incident data, such that CDE 220 can identify an incident from the data. (In addition the data can be added to the data repository to improve incident identification in future.) This incident is sent to feature scoring module 230, which provides information of the authenticity of the features. The output of the feature scoring module 230 and feature summarization module 210 are sent to incident validation module 240, which determines an authenticity score to indicate how likely it is that the incident is authentic.

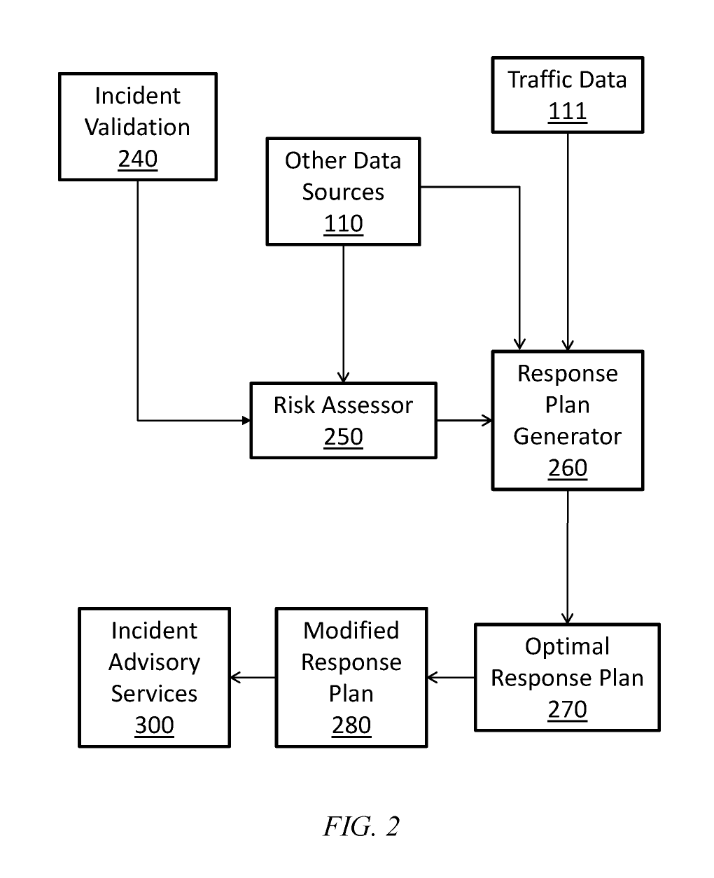

With reference to FIG. 2, there is shown a schematic for obtaining a response plan according to one embodiment of the invention. Incident validation module 240 (as seen also in FIG. 1) provides output that indicates the likelihood of a valid incident. This output is received by risk assessor 250, which, along with data from other data sources 110 (e.g., demography, population density, location, etc.) and still other sources of data such as traffic data 111 (e.g., traffic patterns, instantaneous traffic density, etc.), becomes input to the response plan generator 260. Response plan generator 260 may generate a plurality of response plans that are vetted (either automatically according to criteria or manually) in order to produce optimal response plan 270. Alternatively response plan generator 260 may produce only a single response plan that by default becomes optimal response plan 270. Optimal response play may optionally be further modified manually or automatically to generate modified response plan 280. The final response plan is then sent to incident advisory services 300 such as a cognitive advisor module (not shown/labelled).

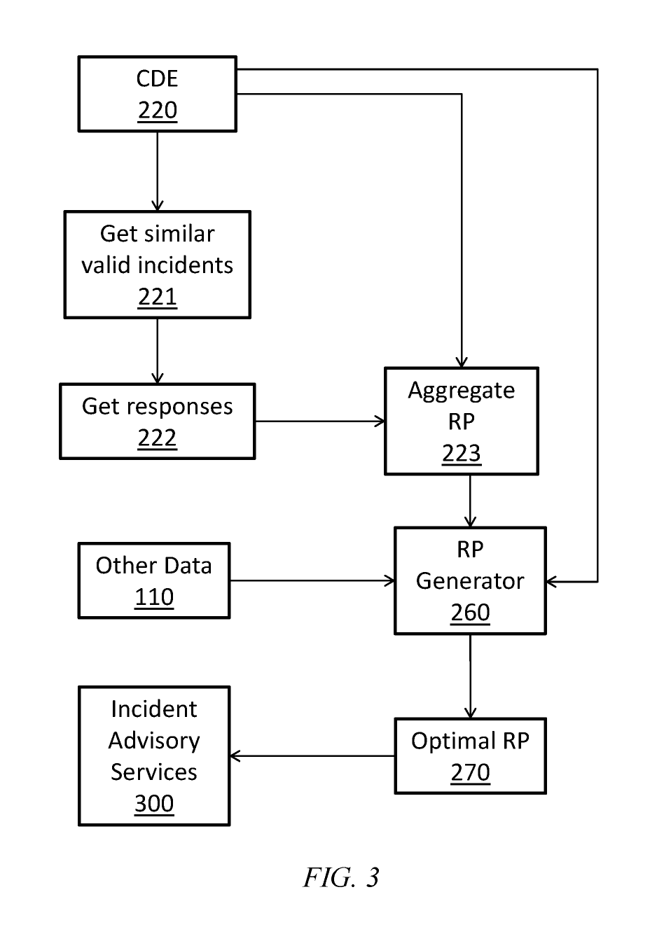

With reference to FIG. 3, there is shown a schematic for obtaining a response plan according to one embodiment of the invention. In the figure, CDE 220 comprises an incident store with valid and ranked incidents and associated data. Then, based on new data about a potential incident, CDE 220 may internally (or externally) get similar valid incidents 221 that are related or seemingly related, and furthermore get responses 222 for each similar incident identified. All of this information is aggregated—i.e., aggregated response plans 223—and given to response plan generator 260 (along with, potentially other data 110) to generate a response plan as described previously. Optimal response plan 270 is then implemented via incident advisory services 300 and similar modules.

In aspects are devices configured to carry out the methods described herein. The devices may comprise a processor and a memory coupled to the processor, the memory configured to store program instructions for instructing the processor to carry out the method. Further details are provided herein. It will be appreciated, however, that certain components of such devices, and further certain steps of the associated methods, may be omitted from this disclosure for the sake of brevity. The omitted components and steps, however, are merely those that are routinely used in the art and would be easily determined and implemented by those of ordinary skill in the art using nothing more than routine experimentation, the general state of the art, and the disclosure herein. Throughout this specification, where hardware is described, it will be assumed that the devices and methods employing such hardware are suitably equipped with necessary software (including any firmware) to ensure that the devices/methods are fit for the described purpose.

Throughout this disclosure, use of the term “server” is meant to include any computer system containing a processor and memory, and capable of containing or accessing computer instructions suitable for instructing the processor to carry out any desired steps. The server may be a traditional server, a desktop computer, a laptop, or in some cases and where appropriate, a tablet or mobile phone. The server may also be a virtual server, wherein the processor and memory are cloud-based.

The methods and devices described herein include a memory coupled to the processor. Herein, the memory is a computer-readable non-transitory storage medium or media, which may include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

Throughout this disclosure, use of the term “or” is inclusive and not exclusive, unless otherwise indicated expressly or by context. Therefore, herein, “A or B” means “A, B, or both,” unless expressly indicated otherwise or indicated otherwise by context. Moreover, “and” is both joint and several, unless otherwise indicated expressly or by context. Therefore, herein, “A and B” means “A and B, jointly or severally,” unless expressly indicated otherwise or indicated otherwise by context.

It is to be understood that while the invention has been described in conjunction with examples of specific embodiments thereof, that the foregoing description and the examples that follow are intended to illustrate and not limit the scope of the invention. It will be understood by those skilled in the art that various changes may be made and equivalents may be substituted without departing from the scope of the invention, and further that other aspects, advantages and modifications will be apparent to those skilled in the art to which the invention pertains. The pertinent parts of all publications mentioned herein are incorporated by reference. All combinations of the embodiments described herein are intended to be part of the invention, as if such combinations had been laboriously set forth in this disclosure.

### Examples

In a hypothetical situation, perpetrators armed with crude weapons broke into a compound of a household appliances company and tied up the guards who had raised an alarm and the members of the Quick Response Team arrived and dispelled the perpetrators. The information is supplied to a system according to this disclosure. Analysis of the situation is carried out as outlined below.

TABLE 1
Extracted features' values for the text incident
({[F_{1, 1}, S_{1, 1}], . . . , [F_{6, 1}, S_{6, 1}]})

| Feature | Entities |
|---|---|
| WHAT | Robbery |
| WHERE | Anytown |
| WHEN | 2300 hrs |
| WHO | Perpetrators, guards, Quick Response Team |
| HOW | Crude weapons |
| WHY | N/A |

To the data was applied the Alchemy API taxonomy classifier, Named Time Entities, IBM® Text relations, and Annotated Query Language (AQL).

The same situation is repeated but in an example of a complete incident extraction process when the incident report contains text and multimedia information (i.e., image, audio and video) from a variety of sources. In such case the respected techniques can produce the following output.

TABLE 2

| | | Image | Audio | Video |
|---|---|---|---|---|
| | Text | (Image | (Audio | (Video |
| | (NLP) | Analytics) | Transcription) | Analytics) |
| WHAT | Robbery | an armed | | |
| | | robbery | | |
| WHERE | Anytown | <1.4500° S, | Nearby the | |
| | | 36.9700° E> | supermarket | |
| WHEN | 2300 hrs | | 11pm | |
| WHO | Perpetrators, | | | two people |
| | guards, Quick | | | with security |
| | Response Team | | | uniform |
| | | | | running |
| HOW | Crude | | | |
| | weapons | | | |
| WHY | | | Robberies | |
| | | | expected | |
| | | | around 11PM | |
| | | | the guards may | |
| | | | take a short | |
| | | | sleep | |

The data in Table 2 above is analyzed to produce a summarized value, which is provided below in Table 3.

TABLE 3

| | | Image | Audio | Video | |
|---|---|---|---|---|---|
| | Text | (Image | (Audio | (Video | Summarized |
| | (NLP) | Analytics) | Transcription) | Analytics) | Value |
| WHAT | Robbery | an armed | | | Robbery |
| | | robbery | | | |
| WHERE | Anytown | <1.4500° S, | Nearby the | | Nearby the |
| | | 36.9700° E> | supermarket | | supermarket, |
| | | | | | <1.4500° S, |
| | | | | | 36.9700° E>, |
| | | | | | Anytown |
| WHEN | 2300 hrs | | 11pm | | 23:00 hr |
| WHO | Perpetrators, | | | two | Perpetrator: |
| | guards, | | | people | perpetrators; |
| | Quick | | | with | Victim: |
| | Response | | | security | Guards, |
| | Team | | | uniform | Household |
| | | | | running | Appliances |
| | | | | | company; |
| | | | | | Responder: |
| | | | | | two security |
| | | | | | officers |
| HOW | Crude | | | | Crude |
| | weapons | | | | weapons |
| WHY | | | Robberies | | Robberies |
| | | | expected | | expected |
| | | | around 11PM | | around 11PM |
| | | | the guards | | the guards |
| | | | may take a | | may take a |
| | | | short sleep | | short sleep |

Based on the above information (particularly but not necessarily Table 3) an operator can launch a Public Safety Insights System, which is a system according to this disclosure. The system may provide a dashboard for the operator including a map and information and analysis of incidents. The operator may further receive information (e.g., phone calls, SMS, etc.) from a security field agent, and the dashboard can be updated accordingly to show the incoming information. Phone calls, SMS, and other data and communications can be routed and controlled through the dashboard.

Furthermore, information about a new incident can be directed to the dashboard of the operator, such as information about a protest. The operator can then, through the dashboard, alert response teams and others that are in position to help with the situation. In an example, the system can utilize cognitive computing tools to enable the system to understand the content of the message and extract incident parameters from the message (e.g., type of incident, location of incident, time of incident, people, etc.). If the operator is not available, the system is configured to pick a call after 3 rings, automatically transcribes the field agent's description, and analyse the credibility and risk level of the incident.

In the example, the initial risk rating that is assigned is Very High. This rating is based on our system's cognitive capabilities. The system is able to learn from historically similar incidents, incorporating information such as population density, sentiment, emergency response time, business and residential impact to determine the overall risk the incident has on the surrounding population, residents and businesses. This risk is then displayed on the dashboard and communicated as appropriate to field agents and other entities.

The system tracks each of the human sources and runs analytics on their reporting history. A credibility score is assigned to each source. In the example, a bystander who was not present at the incident made a report (e.g., on social media). His credibility score is above average, but the operator decides she needs to corroborate the incident before she shares the information with her clients and notifies a first responder team to deploy resources. Corroboration via social media is carried out as per below (other non-social media methods would work similarly).

The operator clicks on social media corroboration. The system automatically generates keywords and a location from the bystander's description. The operator also types in other keywords that she thinks might be useful (e.g., words in a locally-used language). The system automatically sets a time period for the search, which the operator is able edit if she chooses.

The system aggregates and analyzes credible images and texts; it uses these data sources to corroborate a demonstration on a specific road. In addition, if detects additional incident parameters that were not initially reported (i.e., the reason for the incident). The risk level assessor then utilizes this information and updates its risk level.

The example further includes corroboration with human sources, which works as per below.

The operator clicks on the human corroboration tab in the dashboard to further verify an incident. To facilitate corroboration, there are various ways to sort incidents, e.g., based on type, credibility ranking, or estimated time of arrival (ETA which may be based on the system's analysis of contextual data such as traffic and weather information).

Furthermore, the system utilizes road quality data to help predict how long it will take for a person to travel from point A to B on via car, motorcycle taxi, and/or public transportation. For example, weather can affect traffic conditions, and poor road quality will most likely result in traffic congestion.

Based on ETA and the credibility level of the field agent, the operator selects bystander 1 and bystander 2 to try to corroborate the incident. The operator sends a notification to these agents via an integrated mobile reporting app to corroborate the story. Bystander 1 arrives at the location first. With the public safety reporting mobile application (i.e., the mobile application associated with the systems herein), bystander 1 records a short video of the incident and reports that some people near the protest have weapons and that the crowd is getting more aggressive. The system analyzes and aggregates additional incident parameters from video and text data. The system uses both the social media and human source data to corroborate and verify the incident. The system takes the additional information that bystander 1 provided (i.e., weapons and aggression) and re-evaluates the risk level. The risk rating changes from high to severe. This change in risk is communicated through all appropriate channels and to the dashboard of the operator.

Information about the verified incident with an advisory is automatically generated and disseminated (i.e., by SMS, email, mobile app). Customers and clients receive the alert if they are within a 2 km radius of the incident or if they set their alert preference to receive specific alerts. The resource manager of the security company is alerted that the incident has been confirmed and that they should deploy necessary resources. The incident response advisor takes into account the incident and its risk and other contextual data e.g. sensing power outage, road/traffic sensing and generates optimal resource and response plans. Operations by the emergency response teams are monitored (e.g., via social media, direct reports, etc.) and the system and output are continuously updated.

1. A system for incident characterization and response coordination, the system comprising:
an incident data collection module configured to aggregate data from a plurality of sources about an incident;
an analytics module selected from a text analytics engine, an image analytics engine, a video analytics engine, and a speech analytics engine, the analytics module configured to analyze aggregated data collected by the incident data collection module and to output an aggregated data analysis;
a validation engine configured to determine a degree of credibility of the incident based on the aggregated data analysis;
a response planning engine that optimally generates a response plan based on the aggregated data analysis and determined degree of credibility; and
a cognitive advisor module configured to implement at least a portion of the response plan.

2. The system of claim 1, wherein the cognitive advisor module is connected to a network via a communications module and is configured to automatically transmit an instruction or alert via the network to a recipient based on the determined degree of credibility of the incident, wherein the instruction or alert is a component of the response plan.

3. The system of claim 1, further comprising a ranking engine configured to determine an impact factor that the incident poses to a community based on the aggregated data analysis and determined degree of credibility.

4. The system of claim 1, further comprising a contextual characterization module configured to characterize the incident based on contextual factors.

5. The system of claim 1, wherein the analytics module comprises the text analytics engine, the image analytics engine, the video analytics engine, and the speech analytics engine.

6. The system of claim 1, wherein the incident data collection module is configured to aggregate data from sources selected from: a human source; a nonhuman source; a social media platform; a data network; a radio frequency network; a cellular network; and a traditional media platform.

7. The system of claim 1, wherein the response plan coordinates a response to the incident, and comprises at least one instruction for causing an action selected from: an automated action and an action by a recipient.

8. The system of claim 1, wherein the response plan coordinates a response to the incident, and comprises at least one instruction for causing an automated action selected from a dispatch of an emergency service provider, a transmission of an alert signal, a change in the alert status of an emergency response system, and a phone call to an emergency response team.

9. The system of claim 1, wherein the response plan coordinates a response to the incident, and comprises at least one instruction for causing an action by a recipient, the recipient selected from police, emergency health providers, other public emergency service providers, private security, other private emergency service providers, and media reporters.

10. The system of claim 1, wherein the response plan causes the cognitive advisor module to initiate an automatic transmission of a message, or to initiate a change in a user device selected from vibrating the user device, generating beep sounds, blinking, and triggering changes to user interface.

11. The system of claim 1, further comprising an incident qualification engine that analyzes the aggregated data and optional additional data, and assigns additional generic characteristics from a database of similar incidents to the incident.

12. The system of claim 1, further comprising a Graphical User Interface (GUI) controlled by a user, the GUI configured to allow the user to control instructions, alerts or actions according to the response plan.

13.-20. (canceled)
